(19) United States
(12) Patent Application Publication
(10) Pub. No.: US 2015/0169126 A1
(43) Pub. Date: Jun. 18, 2015

(54) INPUT DEVICE, INPUT METHOD, AND COMPUTER-READABLE STORAGE MEDIUM

(71) Applicant: Kunio OZAWA, Kanagawa (JP)

(72) Inventor: Kunio OZAWA, Kanagawa (JP)

(73) Assignee: RICOH COMPANY, LIMITED, Tokyo (JP)

(21) Appl. No.: 14/571,349

(22) Filed: Dec. 16, 2014

(30) Foreign Application Priority Data
Dec. 18, 2013 (JP) 2013-261769

(51) Int. Cl. G06F 3/041

(52) U.S. Cl. CPC G06F 3/0414; G06F 2203/04102

(57) ABSTRACT

An input device according to an embodiment includes an input unit formed to be flexible; a detector that detects bending of the input unit; a determining unit that determines whether the bending detected by the detector meets a preset condition; and an output unit that outputs information appropriate to the condition when the determining unit determines that the bending meets the condition.

### CROSS-REFERENCE TO RELATED APPLICATION

The present application claims priority to and incorporates by reference the entire contents of Japanese Patent Application No. 2013-261769 filed in Japan on Dec. 18, 2013.

### BACKGROUND OF THE INVENTION

1. Field of the Invention

The present invention relates to an input device that inputs information to information processing device, an input method, and a computer-readable storage medium storing therein an input program.

2. Description of the Related Art

Recently, a display device which is freely bendable within a range of a predetermined curvature radius and has flexibility has been developed as disclosed in Japanese Patent No. 5186507, for example. This display device is called “a flexible display” and configured by sandwiching a liquid crystal between transparent electrodes formed, as a substrate, of a composite resin having transparency and elasticity, for example.

An image processing device which has a planar chassis and in which a display surface of a display device occupies a large area of the surface of the chassis (hereinbelow referred to as “tablet computer”) has been in widespread use in recent years. In general, such a tablet computer, which is configured as a touchscreen in which the display device is integrally configured with an input device, allows inputting information by making a finger of a hand in contact with the touchscreen.

Here, an image processing device in which the tablet computer performance and the flexible display performance are combined is considered. In this case, as a method of inputting information in the information processing device, an adoption of a hand finger contact, which is a method of inputting information in a conventional tablet computer, is considered. However, this inputting method does not exactly utilize the flexibility which is a feature of the flexible display and therefore there is a problem of failing to take advantages of the combination of the tablet computer performance and the flexible display performance.

Therefore, there is a need for realizing an input by taking advantage of the configuration with flexibility.

### SUMMARY OF THE INVENTION

It is an object of the present invention to at least partially solve the problems in the conventional technology.

According to an embodiment, there is provided an input device that includes an input unit formed to be flexible; a detector that detects bending of the input unit; a determining unit that determines whether the bending detected by the detector meets a preset condition; and an output unit that outputs information appropriate to the condition when the determining unit determines that the bending meets the condition.

According to another embodiment, there is provided an input method that includes detecting bending of an input unit formed to be flexible; determining whether the bending meets a preset condition; and outputting information appropriate to the condition when it is determined that the bending meets the condition.

According to still another embodiment, there is provided a non-transitory computer-readable storage medium with an executable program stored thereon and executed by a computer. The program instructs the computer to perform: detecting bending of an input unit formed to be flexible; determining whether the bending meets a preset condition; and outputting information appropriate to the condition when it is determined that the bending meets the condition.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 schematically illustrates an information processing device to which an input device according to a first embodiment is applied;

FIG. 2 illustrates a configuration example of the input device according to the first embodiment;

FIG. 3 illustrates an arrangement example of optical fibers for the input device according to the first embodiment;

FIG. 4 illustrates kinds of bending, detectable in the arrangements of the optical fibers according to the first embodiment, of the input device;

FIG. 5 illustrates an example of a state where the entire input device according to the first embodiment is bent in the breadthwise direction;

FIG. 6 illustrates an example of a state where an upper right corner portion of the input device according to the first embodiment is bent;

FIG. 7 illustrates an example in which the input device according to the first embodiment is rolled up into a tubular shape;

FIG. 8 schematically illustrates differences in bending depending on how to bend the input device according to the first embodiment;

FIG. 9 is a functional block diagram of an example for explaining a function of the input device according to the first embodiment;

FIG. 10 is a block diagram of a configuration example of an information processing device applicable to the first embodiment;

FIG. 11 is a flowchart of an example of a processing with respect to an input to the input device according to the first embodiment;

FIG. 12 illustrates an arrangement example of optical fibers in an input device according to a second embodiment;

FIG. 13 illustrates kinds of bending, detectable in the arrangements of the optical fibers according to the second embodiment, of the input device;

FIG. 14 illustrates an example of a state where a right periphery of the input device according to the second embodiment is bent in the breadthwise direction;

FIG. 15 illustrates a configuration example of an input device according to a third embodiment; and

FIG. 16 illustrates an appearance example of a tablet computer applicable to a fourth embodiment and areas set in a touchscreen.

### DETAILED DESCRIPTION OF THE PREFERRED EMBODIMENTS

Exemplary embodiments of an input device, an input method, and a computer-readable storage medium will be explained in detail below with reference to the accompanying drawings.

### First Embodiment

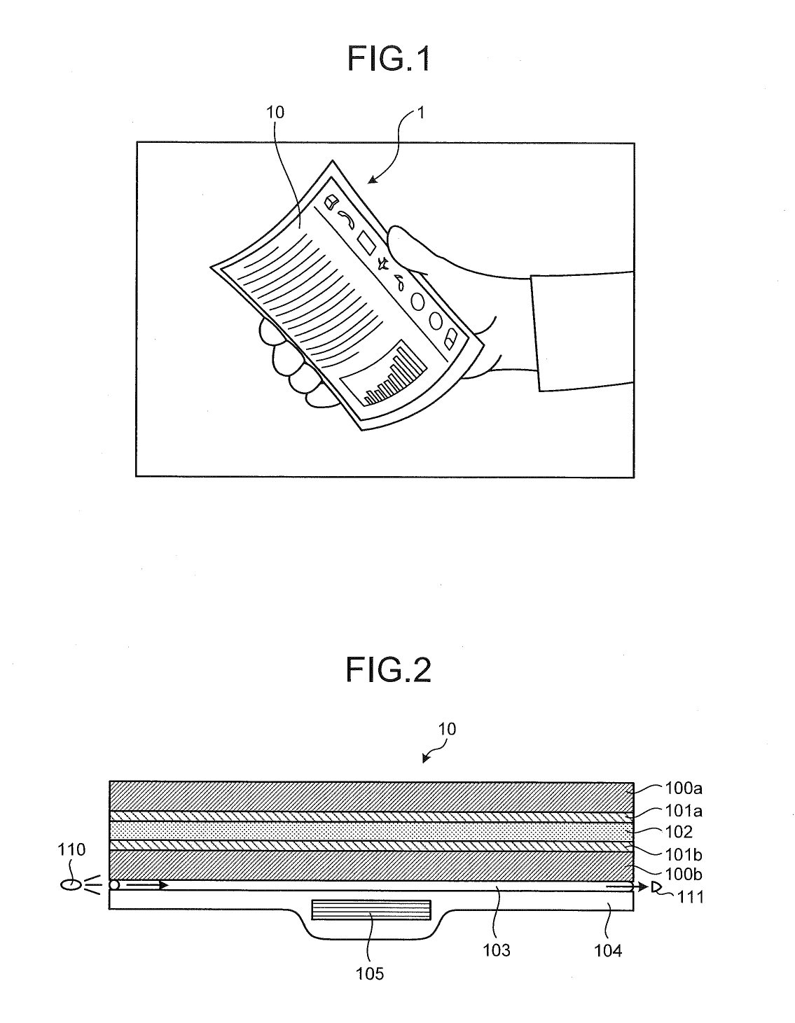

FIG. 1 schematically illustrates an information processing device to which an input device according to a first embodiment is applied. In FIG. 1, an information processing device 1 is provided with an input device 10 according to the first embodiment. In this example, the input device 10 is configured as a touchscreen integrally structured with a display device that displays an image output from the information processing device 1 and configured to have flexibility. In the example in FIG. 1, the information processing device 1 has flexibility as a whole. Here, the input device 10 is not necessarily configured as a touchscreen.

The input device 10 according to the first embodiment, when bent, inputs information depending on the way of the bending. For example, by performing a manipulation of bending the input device 10 totally, a manipulation of rolling up the input device 10 into a tubular shape, a manipulation of bending any one of four corners of the input device 10, a manipulation of bending a periphery in parallel with a side of the input device 10, and the like, a user is able to input information associated with respective manipulations to the information processing device I in the configuration in FIG. 1, a manipulation of bending the input device 10 corresponds to a manipulation of bending the information processing device 1 itself.

For example in consulting an electronic book in the information processing device 1, manipulations through bending the information processing device 1 are associated with respective operations of flipping through a page, turning over pages (flipping through a plurality of pages collectively), creating and cancelling a bookmark, scrolling on a displayed screen, turning off the power source, and the like. When a user bends the information processing device 1, the input device 10 inputs an instruction for an operation appropriate to the way of the bending to the information processing device 1

The user is thus able to consult the electronic book in the information processing device 1 as if the user consulted an actual book. Since information is input by bending the information processing device 1, it is possible to perform an input manipulation with the information processing device 1 in the user's hand and to obtain a good manipulation performance without a necessity, like a general tablet computer, of moving a finger of a right hand or a left hand for tapping.

FIG. 2 illustrates a configuration example of the input device 10 according to the first embodiment. In FIG. 2, the input device 10 is configured integrally with a display device and provided with films 100a and 100b, electrodes 101a and 101b, a liquid crystal layer 102, an optical fiber 103, a covering layer 104, a circuit part 105, a light source 110, and a light receiving unit 111. In FIG. 2, a lower part (the side of the covering layer 104) is a rear surface and an upper part is a front surface.

The films 100a and 100b are, for example, formed of a composite resin to have flexibility. At least the film 100a at the front surface side in the films 100a and 100b is configured to be transparent or semi-transparent. The electrodes 101a and 101b are formed respectively for the films 100a and 100b and the liquid crystal layer 102 is formed by being sandwiched by the electrodes 101a and 101b. The electrode 101a is a transparent common electrode over a whole surface of the input device 10, for example. The electrode 101b is configured to have a structure capable of controlling gradation for each pixel. When the electrode 101b is driven by the circuit part 105 for each pixel depending on an image signal, for example, an oriented state of the liquid crystal in the liquid crystal layer 102 changes for each pixel and an image in accordance with the image signal is displayed via the film 100a. In this manner, the films 100a and 100b, the electrodes 101a and 101b, the liquid crystal layer 102, and the circuit part 105 constitute a display device.

In the input device 10, the optical fiber 103 is arranged on the rear surface of the film 100b. The light source 110 and the light receiving unit 111 are provided respectively at one end and the other end of the optical fiber 103, and the light receiving unit 111 receives a light which is output from the light source 110 and passes in the optical fiber 103 and outputs a signal depending on an amount of the received light. The degree of scattering of the light passing within the optical fiber 103 becomes higher when the optical fiber 103 is bent and the amount of the light to be output decreases. Therefore, the amount of the light to be received by the light receiving unit 111 changes depending on the curvature of the optical fiber 103.

In the first embodiment, the bending of the input device 10 is detected based on the amount of the light to be received by the light receiving unit 111. Specifically, the optical fiber 103 is provided to the display unit constituted by the films 100a and 100b, the electrodes 101a and 101b, and the liquid crystal layer 102 with flexibility, so that an input unit according to the first embodiment is configured.

The covering layer 104 is provided to protect the film 100b at the rear surface side, the optical fiber 103, and the circuit part 105.

Here, a touch detecting layer may further be provided in the input device 10, the touch detecting layer detecting a touch of a finger and the like by sensing pressure or detecting an electrostatic capacity. By providing the input device 10 with the touch detecting layer, it becomes possible to use the input device 10 as a touchscreen.

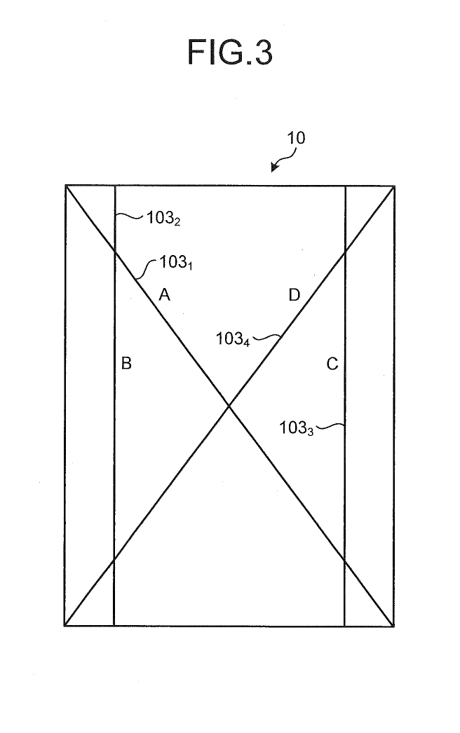

FIG. 3 illustrates an arrangement example of the optical fiber 103 for the input device 10 according to the first embodiment in a state where the input device 10 is seen from the front surface side. To detect various ways of bending of the input device 10, a plurality of optical fibers 103 need to be arranged. In the first embodiment, four optical fibers 103₁, 103₂, 103₃, and 103₄ are arranged in the input device 10 as exemplified in FIG. 3.

Though not illustrated, the light source 110 and the light receiving unit 111 are provided for each of the optical fibers 103₁ to 103₄. It is thus possible to detect a change in light amount due to the bending of each of the optical fibers 103₁ to 103₄ independently for each of the optical fibers 103₁ to 103₄.

In FIG. 3, the optical fibers 103₁ and 103₄ are arranged on respective diagonal lines of the input device 10 having a rectangular shape. In the example in FIG. 3, the optical fiber 103₁ is arranged on a diagonal line connecting an upper left corner and a lower right corner (this arrangement is treated as “arrangement A”). The optical fiber 103₄ is arranged on a diagonal line connecting an upper right corner and a lower left corner of the input device 10 (this arrangement is treated as “arrangement D”).

In FIG. 3, the optical fibers 103₂ and 103₃ are arranged in parallel with a long side of the input device 10 (these arrangements are respectively treated as arrangements B and C). Besides, the optical fibers 103₂ and 103₃ are arranged at both sides of an intersecting position of the optical fibers 103₁ and 103₄, i.e., of a center position of the input device 10, and arranged nearly at midpoints between the center position and respectively corresponding sides. Where to arrange the optical fibers 103₂ and 103₃ between the center position and respectively corresponding sides is determined depending on what bending position you want to be detected.

The arrangement of the optical fiber 103 in the input device 10 not limited to the example in FIG. 3. For example, the optical fiber 103 may be arranged in a matrix state with respect to the input device 10. It is considered in this case that the number of the optical fiber 103 increases compared to the example in FIG. 3 and the number of the light source 110 and the number of the light receiving unit 111 accordingly increase. The shape of the input device 10 is not limited to the rectangular shape.

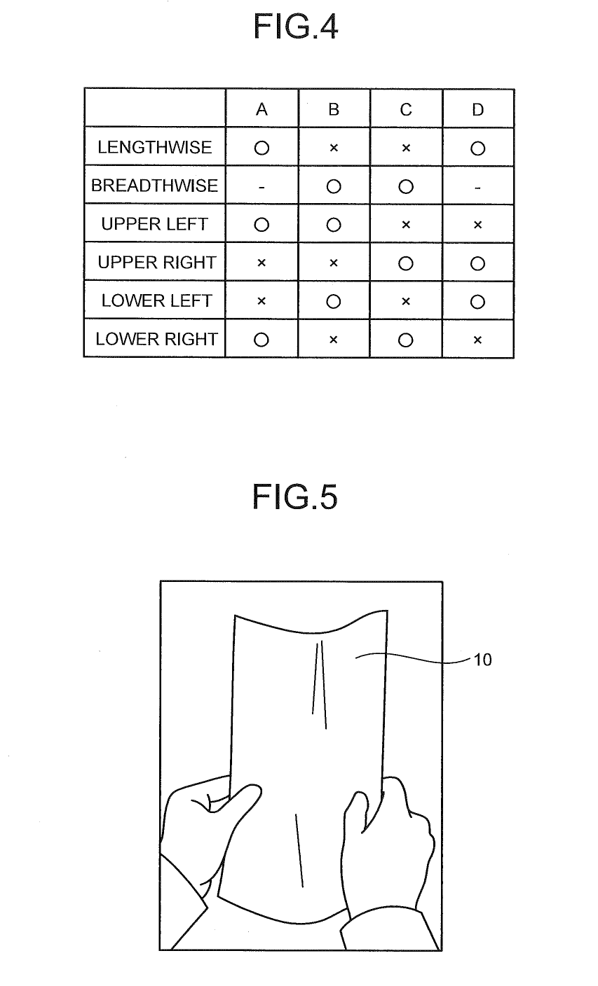

FIG. 4 illustrates kinds of bending, detectable in the arrangements A to D of the respective optical fibers 103 to 103₄ illustrated in FIG. 3 according to the first embodiment, of the input device 10. In FIG. 4, a mark “o” (circle) indicates that a decrease in the amount of light is detected in the light receiving unit 111 of the relevant optical fiber 103 in the arrangement and a mark “x” (cross) indicates that the decrease in the amount of light is not detected in the relevant light receiving unit 111.

With reference to FIG. 4, when the decrease in the amount of light is detected in the arrangements A and D (the optical fibers 103₁ and 103₄) and is not detected in the arrangements B and C (the optical fibers 103₂ and 10₃), it is possible to determine that the entire input device 10 is bent in the lengthwise direction (short side), i.e., bent with an axis parallel to the long side in FIG. 3. FIG. 5 illustrates an example of a state where the entire input device 10 is bent in the breadthwise direction.

When the decrease in the amount of light is detected in the arrangements B and C, it is possible to determine that the entire input device 10 is bent in the lengthwise direction (long side), i.e., bent with an axis parallel to the short side in FIG. 3. In this case, detection results of the arrangements A and D are ignored.

When the decrease in the amount of light is detected in the arrangements A and B and not detected in the arrangements C and D, it is possible to determine that an upper left corner portion of the input device 10 is bent. This is a state where the input device 10 is bent on an axis of a line connecting one point in the left long side of the input device 10 and one point locating between an inner side from the arrangement C and an inner side from the arrangement B in the upper side in FIG. 3. The depiction of the curvature at this corner portion similarly applies to the other corner portions.

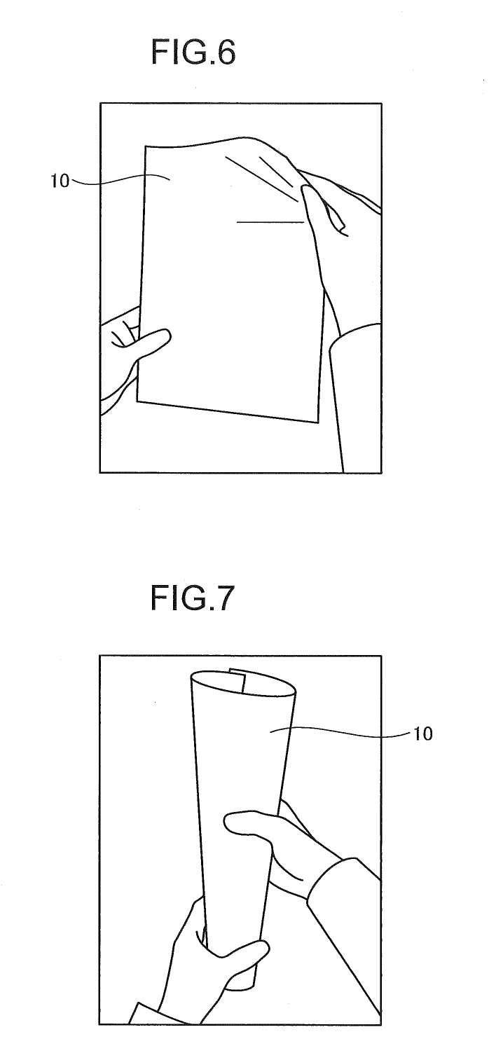

When the decrease in the amount of light is not detected in the arrangements A and B and is detected in the arrangements C and D, it is possible to determine that an upper right corner portion of the input device 10 is bent. FIG. 6 illustrates an example of the state where the upper right corner portion of the input device 10 is bent. When the decrease in the amount of light is not detected in the arrangements A and C and is detected in the arrangements B and D, it is possible to determine that a lower left corner portion of the input device 10 is bent. When the decrease in the amount of light is detected in the arrangements A and C and not detected in the arrangements B and D, it is possible to determine that a lower right corner portion of the input device 10 is bent.

Here, when the degree of the curvature is further increased in the example, illustrated in FIG. 5, of bending the input device 10 in the breadthwise direction, it is possible to roll up the input device 10 into a tubular shape as exemplified in FIG. 7. Besides, it is possible to bend, in a manner of folding, the input device 10 within a range of a predetermined curvature radius by applying a force onto the input device 10 so that the axis of the curvature is accentuated in the example in FIG. 5.

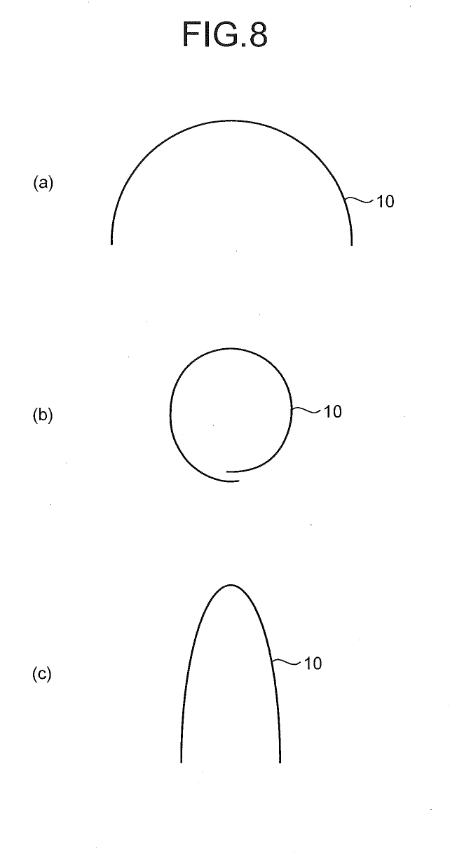

FIG. 8 schematically illustrates differences in curvature depending on how to bend the input device 10. In FIG. 8, (a) illustrates an example of the case of bending the input device 10 like the example in FIG. 5 (referred to as “simple bending”), (b) illustrates an example of the case of rolling up the input device 10 like the example in FIG. 7 (referred to as “roll up”), and (c) illustrates an example of the case of folding the input device 10 (referred to as “fold”). In this manner, the degree of curvature of the input device 10 differs depending on the way of bending the input device 10. In the examples in FIG. 8, (a) illustrates the lowest degree of curvature and (c) illustrates the highest degree of curvature.

As the degree of curvature of the input device 10 is higher, the curvature radius of the optical fiber 103 becomes smaller and the amount of light to be received by the light receiving unit 111 becomes smaller. In other words, the amount of light to be received by the light receiving unit 111 corresponds to the degree of curvature of the input device 10. It is therefore possible by performing a determination based on thresholds set in advance depending on respective degrees illustrated in (a) to (c) in FIG. 8, for example to discriminate the kinds of curvature given to the input device 10 among the “simple bending”, the “roll up”, and the “fold” and to perform an input depending on each kind of curvature by the input device 10.

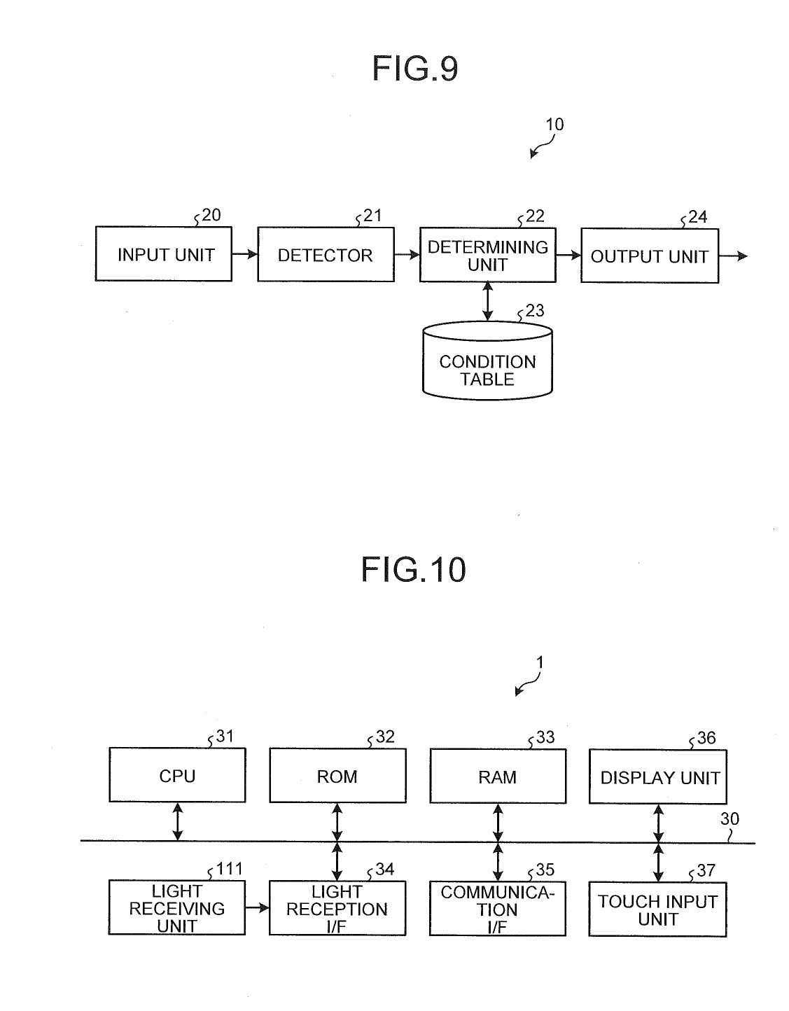

FIG. 9 is a functional block diagram of an example for explaining a function of the input device 10 according to the first embodiment. The input device 10 is provided with an input unit 20, a detector 21, a determining unit 22, a condition table 23, and an output unit 24.

The input unit 20 is, for example, provided with the light source 110, the optical fiber 103, and the light receiving unit 111 illustrated in FIG. 2 and receives an input through the bending of the input device 10. The detector 21 detects bending with respect to the input unit 20. For example, the detector 21 analyzes an output by the light receiving unit 111 to detect the amount of light received by the light receiving unit 111.

The determining unit 22 refers to the condition table 23 based on the light amount detected by the detector 21 and determines the kind of the bending input to the input device 10. In the condition table 23, the detections in the arrangements A to D of the optical fibers 103₁ to 103₄ are associated with the kinds of bending as illustrated in FIG. 4, respectively, for example. In the condition table 23, the degree of curvature and the kind of bending illustrated in (a) to (c) in FIG. 8 may further be associated.

The output unit 24 outputs information input depending on a result of the determination by the determining unit 22.

A part or all of the function of the detector 21 and the functions of the determining unit 22 and the output unit 24 may be configured by respective independent hardwares or may be configured by a program that runs on a central processing unit (CPU).

FIG. 10 illustrates a configuration example of the information processing device 1 applicable to the first embodiment. The information processing device 1 is provided with a CPU 31, a read only memory (ROM) 32, a random access memory (RAM) 33, a light reception I/F 34, a communication I/F 35, a display unit 36, and a touch input unit 37. The CPU 31, the ROM 32, the RAM 33, the light reception I/F 34, the communication I/F 35, the display unit 36, and the touch input unit 37 are, for example, connected via a bus 30 in such a manner that a communication thereamong is allowed.

The CPU 31 uses the RAM 33 as a work memory and operates in accordance with the program stored in advance in the ROM 32 to generally control the information processing device 1. The ROM 32 is further capable of storing in advance the condition table 23 illustrated in FIG. 9. The light reception I/F 34, which is connected to the light receiving unit 111 and receives an output therefrom, converts the output by the light receiving unit 111 into digital data for example and outputs the digital data. The CPU 31 analyzes the output, input via the light reception I/F 34, by the light receiving unit 111, performs a condition determination based on a result of the analysis, and executes an operation in accordance with a bending input to the input device 10.

The communication I/F 35 communicates with an external device via a wireless communication or a wired communication. The display unit 36 generates a driving signal of driving the circuit part 105 in FIG. 2 depending on a display control signal output from the CPU 31, for example. The information processing device 1 is thus able to cause the display device made up of the films 100a and 100b, the electrodes 101a and 101b, the liquid crystal layer 102, and the circuit part 105 to perform a display in accordance with the program.

The touch input unit 37 is, for example, configured integrally with the display device constituted by the films 100a and 100b, the electrodes 101a and 101b, the liquid crystal layer 102, and the circuit part 105 and detects a touch of a finger and the like by sensing pressure or detecting an electrostatic capacity. In other words, the touch input unit 37 and the display device constitute a touchscreen.

Programs for executing a part or all of the detector 21 and executing the determining unit 22 and the output unit 24 may be provided by being, for example, recorded in a file of an installable format or of an executable format in a computer-readable storage medium such as a CD and a DVD.

The programs may be provided by being stored on a computer connected to a communication network such as the Internet and downloaded via the communication network. Besides, the programs may be provided or distributed via the communication network such as the Internet.

The programs for realizing the function of the input device 10, for example, have a module configuration including the components explained above (a part or all of the detector 21, the determining unit 22, and the output unit 24). As an actual hardware, the CPU 31 reads out and executes the programs from the ROM 32, so that each of the components is loaded on a main storage device (the RAM 33, for example) and generated on the main storage device.

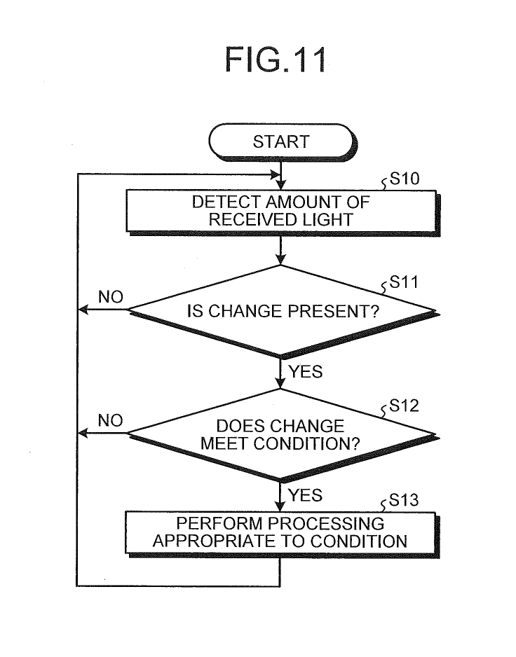

FIG. 11 is a flowchart of an example of a processing with respect an input to the input device 10 according to the first embodiment. At step S10, the determining unit 22 obtains information indicating an amount of the light received by the light receiving unit 111 from the detector 21 to detect the amount of the light received by the light receiving unit 111. The information indicating the obtained light amount is, for example, stored in the RAM 33.

Next at step S11, the determining unit 22 determines whether or not the amount of the received light obtained at step S10 changes compared to the amount of the received light previously obtained. For example, the determining unit 22 calculates a difference between the amount of the received light obtained at step S10 and the amount of the received light previously obtained and compares the difference with a threshold. The determining unit 22 determines that the amount of the received light has changed when determining that the amount of the received light obtained this time decreases by equal to or more than the threshold from the amount of the received light previously obtained as a result of the comparison. The determining unit 22 gets the processing back to step S10 when determining that the amount of the received light has not changed.

When determining that the amount of the received light has changed at step S11, the determining unit 22 causes the processing to move to step S12. The determining unit 22 determines whether or not the change of the amount of the received light determined at step S11 meets a preset condition at step S12. When determining that the change of the amount of the received light does not meet the condition, the determining unit 22 gets the processing back to step S10. On the other hand, when determining that the change of the amount of the received light meets the condition, the determining unit 22 causes the processing to move to step S13.

For example, the determining unit 22 determines what in the optical fibers 103₁ to 103₄ shows a decrease in the amount of the received light at step S11. The determining unit 22 may further determine a degree of decrease in the amount of the received light. Next at step S12, the determining unit 22 refers to the condition table 23 and determines the kind of the bending in accordance with a combination of the optical fibers 103₁ to 103₄ whose amount of the received light has decreased.

At step S13, the determining unit 22 executes a processing appropriate to the condition determined at step S12. For example, the determining unit 22 generates a control signal appropriate to the kind of the bending determined with reference to the condition table 23 at step S12. The generated control signal is, for example, output from the output unit 24 to an information processing program to be executed by the CFU 31 in the information processing device 1. After the processing at step S13 ends, the processing is put back to step S10.

The kind of the information processing program to be executed in the information processing device 1 is not peculiarly limited. In the information processing program, an operation appropriate to the kind of each bending determined by the determining unit 22 is set in advance. As the operation appropriate to the kind of each bending, a power source control of turning on and off the power of the information processing device 1 and a display control of flipping through a page in consulting an electronic book can be listed. The operation appropriate to the kind of each bending is not limited thereto and other operations may be adopted.

As one example, an operation appropriate to each kind of bending in a case of an electronic book consulting program by which an electronic book is consulted will be explained. Here, the electronic book consulting program is assumed to enable flipping through a page of an electronic book which is side stapled. In this case, “Breadthwise”, “Upper Left”, and “Upper Right” among the kinds of bending illustrated in FIG. 4 are assumed to be defined in the electronic book consulting program, for example. Besides, the “simple bending”, the “roll up”, and “fold” as exemplified in (a) to (c) in FIG. 8 are assumed to be defined with respect to the “Breadthwise” in the electronic book consulting program.

In the electronic book consulting program, the kind of the bending “Breadthwise” with the “simple bending”, for example is defined as an operation of flipping through pages one by one continuously. In the electronic book consulting program, the kind of the bending “Breadthwise” with the “roll up” is defined as an instruction of turning off the power source of the information processing device 1. In the electronic book consulting program, the kind of the bending “Upper Left” or the “Upper Right” with the “fold”, for example is defined as a specification of a page in display as a bookmark. In the electronic book consulting program, the kind of the bending “Breadthwise” with the “fold” may be defined as an operation of providing a bookmark. Moreover, the bending for specifying the bookmarked page as a bookmark again is defined as a cancelation of the bookmark of the page.

By defining, through associating with each kind of bending of the input device 10, each operation of the electronic book consulting program in this manner, it is possible by bending the input device 10 to perform a page manipulation and the like in the electronic book consulting program.

### Second Embodiment

Next, a second embodiment will be explained. A second embodiment is configured to enable a detection of a state where only a periphery of the input device 10 is bent. Since the configuration of the input device 10 and the information processing device 1 explained with reference to FIGS. 9 and 10 can be applied as it is to the second embodiment, the configuration will not be explained again.

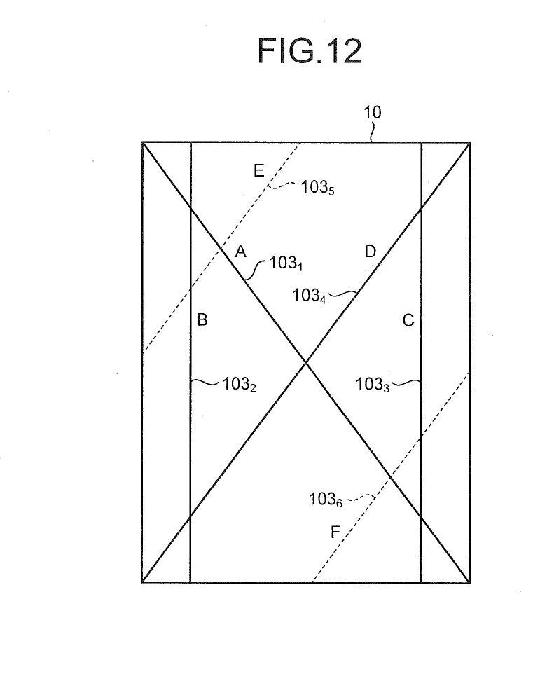

FIG. 12 illustrates an arrangement example of an optical fiber 103 in an input device 10 according to the second embodiment. As illustrated in FIG. 12, optical fibers 103₅ and 103₆ are arranged in addition to the optical fibers 103₁ to 103₄ illustrated in FIG. 3 in the input device 10 according to the second embodiment.

In FIG. 12, the optical fiber 103₅ is arranged as a line connecting two sides which are in contact with each other at one point (treated as the first point) in the input device 10 having a rectangular shape (this arrangement is treated as “arrangement E”). Besides, the optical fiber 103₆ is arranged as a line connecting two sides which are in contact with each other at one point (treated as the second point) locating at a diagonal of the first point (this arrangement is treated as “arrangement F”). On this occasion, the arrangements E and F are determined so that respective projections of the respective lines with respect to the sides do not overlap to each other.

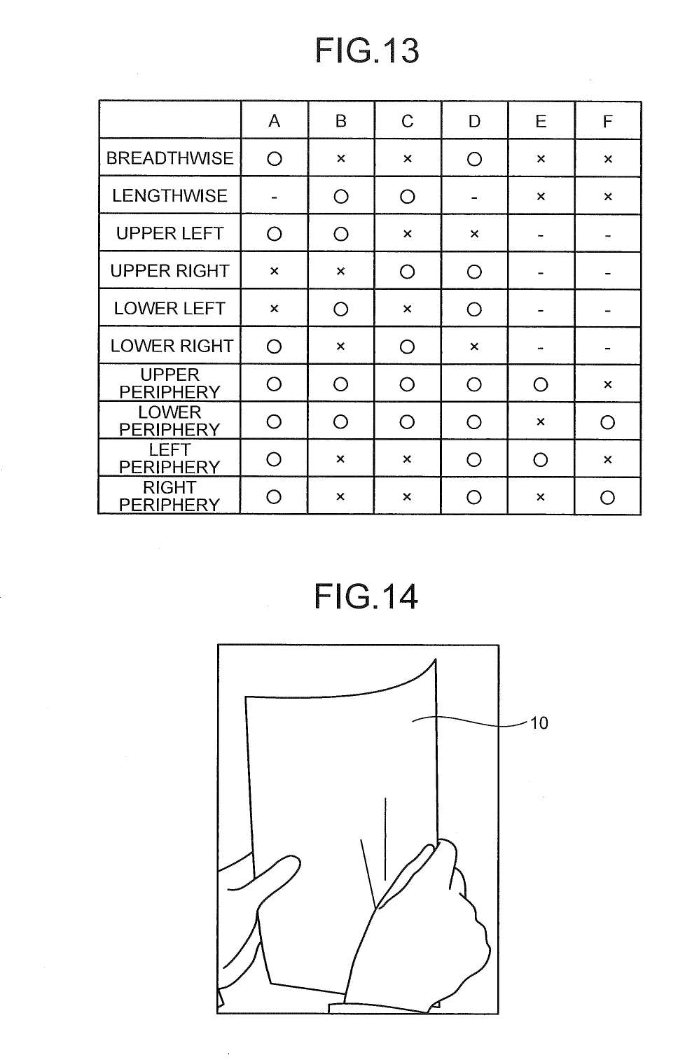

FIG. 13 illustrates kinds of curvature, detectable in the arrangements A to F of the optical fibers 103₁ to 103₆ illustrated in FIG. 12, according to the second embodiment, of the input device 10. The kinds of detectable bending illustrated in FIG. 13 include “Upper Periphery”, “Lower Periphery”, “Left Periphery”, and “Right Periphery” in addition to the kinds of bending illustrated in FIG. 4. Since the arrangements A to D with respect to the “Breadthwise”, “Lengthwise”, “Upper Left”, “Upper Right”, “Lower Left”, and “Lower Right” among the kinds of bending have the same results as illustrated in FIG. 4 and will not be explained again here.

When the decrease in the amount of light is detected in the arrangements A to D and is detected in the arrangement E with reference to FIG. 13, it is possible to determine that the upper periphery of the input device 10 is bent in the lengthwise direction in FIG. 12. When the decrease in the amount of light is detected in the arrangements A to D and is detected in the arrangement F, it is possible to determine that the lower periphery of the input device 10 is bent in the lengthwise direction.

When the decrease in the amount of light is detected in the arrangements A and D and is detected in the arrangement E, it is possible to determine that the left periphery of the input device 10 is bent in the breadthwise direction. When the decrease in the amount of light is detected in the arrangements A and D and is detected in the arrangement F, it is possible to determine that the right periphery of the input device 10 is bent in the breadthwise direction as exemplified in FIG. 14.

For the detection of the bending in the breadthwise direction and the lengthwise direction, it is necessary that the decrease in the amount of light is not detected in the arrangements E and F in addition to the conditions of the arrangements A to D illustrated in FIG. 4. For the detection of the bending at the upper left corner portion, the upper right corner portion, the lower left corner portion, and the lower right corner portion, the detection results of the arrangements E and F are ignored as shown by “-” (hyphen) in FIG. 4.

An example of applying the detection of the bending only at a periphery according to the second embodiment to the electronic book consulting program will be explained. When the electronic book consulting program enables flipping through pages from the left side in an electronic book which is side stapled, it is considered that the bending at the left periphery is defined as an operation of flipping through pages at high speed compared to the case of the “Breadthwise” with the “simple bending”, for example. In this case, it is considered that the bending at the left periphery is defined as an operation of flipping pages forward and the bending at the right periphery is defined as an operation of flipping back pages.

As explained so far, it becomes possible according to the second embodiment to detect the bending at the left and right peripheries and the upper and lower peripheries in addition to the bending in the breadthwise direction, the lengthwise direction, and each corner portion according to the first embodiment.

### Third Embodiment

Next, a third embodiment will be explained. It is impossible in the first and the second embodiments to detect a concave and a convex of a curvature caused due to bending the input device 10, i.e., which side the input device 10 is bent to, the front surface side or the rear surface side. The third embodiment enables detecting the concave and the convex of a curvature of the input device 10.

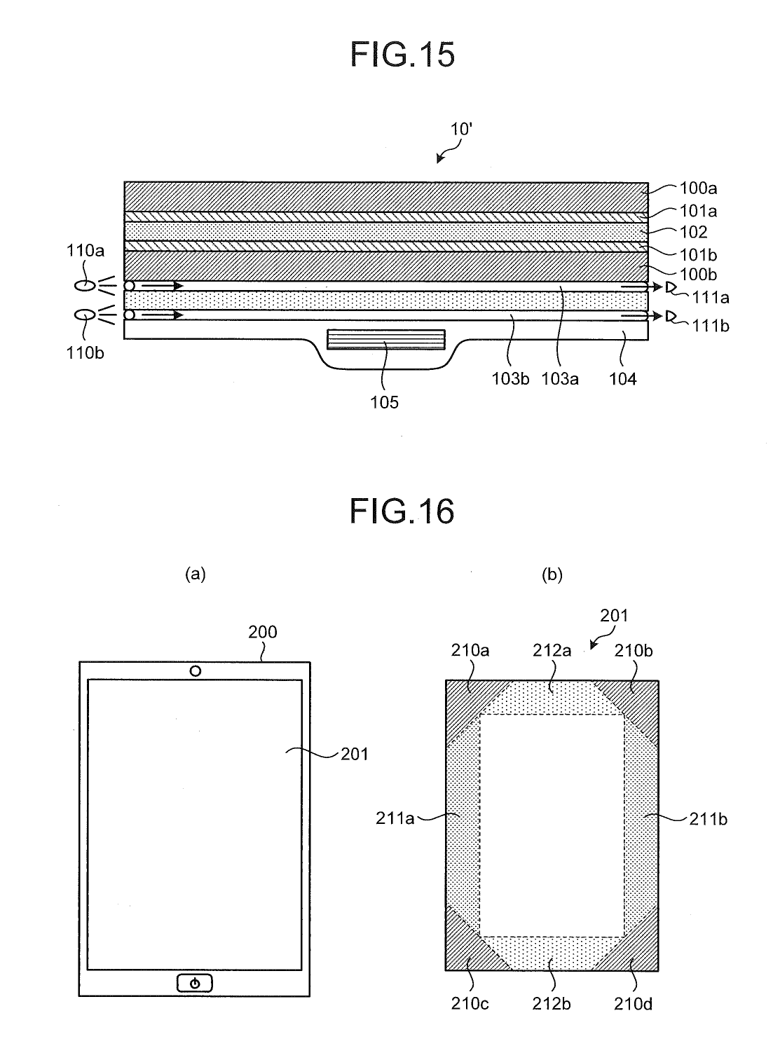

FIG. 15 illustrates a configuration example of an input device 10′ according to a third embodiment. In FIG. 15, the same part as illustrated in FIG. 2 is assigned with the same reference symbol and a detailed explanation thereof will be omitted here.

As illustrated in FIG. 15, the input device 10′ is provided with double layer optical fibers 103a and 103b. Light sources 110a and 110b and light receiving units 111a and 111b are respectively provided to the optical fibers 103a and 103b. The optical fibers 103a and 103b are layered and arranged in the input device 10′ just like the arrangements A to D in the first embodiment, for example.

The determining unit 22 compares respective detection results by the detector 21 in accordance with outputs of the light receiving units 111a and 111b to calculate a difference in the amount of light received by the light receiving units 111a and 111b. The determining unit 22 then determines which direction the input device 10′ is bent to, a concave direction or a convex direction depending on the difference.

Specifically, the double-layered optical fibers 103a and 103b are bent in a direction of a thickness of the layer, the optical fibers 103a and 103b have difference in curvature radius and respective amounts of light to be received by the light receiving units 111a and 111b become different from each other depending on the difference in curvature radius. The determining unit 22 determines that the input device 10′ is bent to be convex to the side of the front surface when the amount of light received by the light receiving unit 111a is more than the amount of light received by the light receiving unit 111b, and that the input device 10′ is bent to be convex to the side of the rear surface when the amount of light received by the light receiving unit 111a is less than the amount of light received by the light receiving unit 111b through a comparison of the light amounts received by the light receiving units 111a and 111b.

An example of applying the detection of the bending of the input device 10′ in the concave/convex direction according to the third embodiment to the electronic book consulting program will be explained. In the electronic book consulting program, it is considered that the case where the input device 10′ is bent to be convex to the side of the front surface is defined as an operation of enlarging and displaying a page currently displayed and the case where the input device 10′ is bent to be convex to the side of the rear surface is defined as an operation of reducing and displaying the page currently displayed, for example.

It is possible to incorporate the detection of the bending in the concave/convex direction in the input device 10′ according to the third embodiment with the detection of the kinds of the bending in the first and the second embodiments.

As explained so far, it is possible according to the third embodiment to detect the bending in the concave/convex direction of the input device 10′ in addition to the bending according to the first and the second embodiments. It thus becomes possible to define more operations.

### Fourth Embodiment

Next, a fourth embodiment will be explained. A fourth embodiment is an example of applying the input device 10 according to the first embodiment or the second embodiment to a tablet computer. An explanation on the assumption that the input device 10 according to the second embodiment is applied to a tablet computer will be made below.

In FIG. 16, (a) illustrates an appearance example of a tablet computer applicable to the fourth embodiment. In (a) in FIG. 16, a tablet computer 200 is provided with a touchscreen 201. The tablet computer 200 is provided with a CPU, a ROM, a RAM, a display unit, an input unit, a communication I/F, and the like similarly to a general computer. The CPU uses the RAM as a work memory and controls components in accordance with the program stored in advance in the ROM, so that the tablet computer 200 operates. The display unit and the input unit are integrally formed to constitute the touchscreen 201 in the tablet computer 200.

In a program of performing a control in accordance with an input to the touchscreen 201 according to the fourth embodiment, areas 210a to 210d, 211a and 211b, and 212a and 212b as exemplified in (b) in FIG. 16 are set with respect to the touchscreen 201. More specifically, the areas 210a to 210d detect touches onto the upper left corner portion, the upper right corner portion, the lower left corner portion, and the lower right corner portion of the touchscreen 201, respectively. The areas 211a and 211b detect touches onto the left periphery and the right periphery of the touchscreen 201, respectively. The areas 212a and 212b detect touches onto the upper periphery and the lower periphery of the touchscreen 201, respectively.

The program according to the fourth embodiment enables assuming that the touchscreen 201 is bent similarly to the input device 10 in accordance with the result of the detection of the touches onto the areas 210a to 210d, 211a and 211b, and 212a and 212b and performing the determination as exemplified in FIG. 13. The program enables determining the bending in the breadthwise direction when the areas 211a and 211b are touched at the same time, for example. Similarly, the program enables determining the bending in the lengthwise direction when the areas 212a and 212b are touched at the same time, for example.

As explained so far, it is possible to apply the processing of the input device 10 according to the first and the second embodiments to the tablet computer 200. This can be realized by installing a program conforming to the program for realizing the input device 10 according to the first and the second embodiments in the tablet computer 200 of general type, for example.

According to an embodiment, there is an advantage of realizing an input by taking advantage of the configuration with flexibility.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

The present invention can be implemented in any convenient form, for example using dedicated hardware, or a mixture of dedicated hardware and software. The present invention may be implemented as computer software implemented by one or more network processing apparatus. The network can comprise any conventional terrestrial or wireless communications network, such as the Internet. The processing apparatus can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implemental on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. An input device comprising:
an input unit formed to be flexible;
a detector that detects bending of the input unit;
a determining unit that determines whether the bending detected by the detector meets a preset condition; and
an output unit that outputs information appropriate to the condition when the determining unit determines that the bending meets the condition.

2. The input device according to claim 1, wherein
the detector detects a degree of curvature caused due to the bending, and
the condition used by the determining unit includes whether the degree of curvature exceeds a threshold.

3. The input device according to claim 1, wherein
the input unit has a rectangular shape, and
the condition used by the determining unit includes a curvature caused due to bending along an axis connecting two sides which are in contact at one point.

4. The input device according to claim 1, wherein
the input unit has a rectangular shape, and
the condition used by the determining unit includes a curvature caused due to bending along an axis which is parallel to one side of the input unit and whose distance to the one side is shorter than a distance to an opposite side of the one side.

5. The input device according to claim 1, wherein
the detector further detects which one of a direction of a first surface and a direction of a second surface that is on a rear surface side of the first surface the bending of the input unit is oriented to, and
the condition used by the determining unit includes which one of the direction of the first surface and the direction of the second surface the bending of the input unit is oriented to.

6. The input device according to claim 1, wherein
the input unit includes an optical fiber provided to be bent in accordance with the bending, and
the detector detects the bending of the input unit based on an amount of light passing in the optical fiber.

7. The input device according to claim 6, wherein
the input unit has a rectangular shape, and
the optical fiber is provided, with respect to a surface of the input unit, along diagonal lines of the input unit, along an inward which is parallel to one side of the input unit and locates at a predetermined distance from the one side, and along an inward which is parallel to the one side of the input unit and locates at the predetermined distance from an opposite side of the one side.

8. The input device according to claim 7, wherein
the optical fiber is provided, with respect to the surface of the input unit, along a line connecting two sides which are in contact at a first point and along a line connecting two sides which are in contact at a second point locating at a diagonal of the first point so that projections of the respective lines with respect to the sides do not overlap to each other.

9. An input method comprising:
detecting bending of an input unit formed to be flexible;
determining whether the bending meets a preset condition; and
outputting information appropriate to the condition when it is determined that the bending meets the condition.

10. The input method according to claim 9, wherein
the detecting includes detecting a degree of curvature caused due to the bending, and
the condition used at the determining includes whether the degree of curvature exceeds a threshold.

11. The input method according to claim 9, wherein
the input unit has a rectangular shape, and
the condition used at the determining includes a curvature caused due to bending along an axis connecting two sides which are in contact at one point.

12. The input method according to claim 9, wherein
the input unit has a rectangular shape, and
the condition used at the determining includes a curvature caused due to bending along an axis which is parallel to one side of the input unit and whose distance to the one side is shorter than a distance to an opposite side of the one side.

13. The input method according to claim 9, wherein
the detecting includes detecting which one of a direction of a first surface and a direction of a second surface that is on a rear surface side of the first surface the bending of the input unit is oriented to, and
the condition used at the determining includes which one of the direction of the first surface and the direction of the second surface the bending of the input unit is oriented to.

14. The input method according to claim 9, wherein
the input unit includes an optical fiber provided to be bent in accordance with the bending, and
the detecting includes detecting the bending of the input unit based on an amount of light passing in the optical fiber.

15. The input method according to claim 14, wherein
the input unit has a rectangular shape, and
the optical fiber is provided, with respect to a surface of the input unit, along diagonal lines of the input unit, along an inward which is parallel to one side of the input unit and locates at a predetermined distance from the one side, and along an inward which is parallel to the one side of the input unit and locates at the predetermined distance from an opposite side of the one side.

16. The input method according to claim 15, wherein
the optical fiber is provided, with respect to the surface of the input unit, along a line connecting two sides which are in contact at a first point and along a line connecting two sides which are in contact at a second point locating at a diagonal of the first point so that projections of the respective lines with respect to the sides do not overlap to each other.

17. A non-transitory computer-readable storage medium with an executable program stored thereon and executed by a computer, wherein the program instructs the computer to perform:
detecting bending of an input unit formed to be flexible;
determining whether the bending meets a preset condition; and
outputting information appropriate to the condition when it is determined that the bending meets the condition.
